(19) United States
(12) Patent Application Publication
(10) Pub. No.: US 2016/0105092 A1
(43) Pub. Date: Apr. 14, 2016

(54) DISCHARGE CONTROL DEVICE

(71) Applicant: AISIN AW CO., LTD., Aichi (JP)

(72) Inventors: Yuji TAKAKURA, Anjo (JP); Yasushi NAKAMURA, Nishio (JP)

(73) Assignee: AISIN AW CO., LT.D, Anjo-shi, Aichi-ken (JP)

(21) Appl. No.: 14/893,364

(22) PCT Filed: Mar. 18, 2014
(86) PCT No.: PCT/JP2014/057305

§ 371 Date: Nov. 23, 2015

(30) Foreign Application Priority Data
Jul. 11, 2013 (JP) 2013-145620

(51) Int. Cl. H02M 1/00; H02M 1/44; H02P 27/06; H02M 7/5387

(52) U.S. Cl. CPC H02M 1/00; H02M 7/53871; H02M 1/44; H02P 27/06

(57) ABSTRACT

A discharge control device where the discharge circuit is configured by a series circuit including a discharging resistor and a discharge control switch; and the discharge control unit controls the discharge control switch to a non-conducting state during non-discharge control in which the discharge control is not executed, and controls the discharge control switch to a conducting state during execution of the discharge control.

### BACKGROUND

The present disclosure relates to a discharge control device that discharges electrical charges accumulated in a smoothing capacitor.

An electrical circuit achieves a predetermined function when power for operating the circuit is supplied. The stability of the operation of the circuit is lowered unless the power is stable, and thus a smoothing capacitor is provided between a power source which supplies the power and the electrical circuit, in most cases, to stabilize the power. Even if the supply of the power from the power source is cut off, electrical charges are accumulated in the smoothing capacitor, and such electrical charges gradually decrease by natural discharge. However, when the electrical circuit is operated at a relatively high voltage of 50V or higher and at a consumption current of a few amperes or higher, for example, the capacitance of the smoothing capacitor becomes large accordingly, and the time in which the electrical charges decrease by natural discharge also becomes long. The electrical charges of the smoothing capacitor are preferably discharged rapidly by considering that the electrical circuit is inspected after electrical connection of the power source and the smoothing capacitor is cut off.

Japanese Patent Application Publication No. 2011-234507 discloses a technique of rapidly discharging electrical charges of a smoothing capacitor connected on the DC side of an inverter when the electrical connection is cut off by a contactor in a power converting device including the contactor between a battery serving as the power source and the inverter serving as the electrical circuit, the contactor electrically connecting and cutting off the battery and the inverter. In the following description, the numbers in the parentheses are reference numerals denoted in the figures of Japanese Patent Application Publication No. 2011-234507. According to Japanese Patent Application Publication No. 2011-234507, a discharge circuit is connected in parallel to a smoothing capacitor (500), the discharge circuit being configured by a resistor (25) and a discharge switching element (26) connected in series to the resistor (25). At the time of rapid discharge, the discharge switching element (26) is conducted so that the electrical charges accumulated in the smoothing capacitor (500) are consumed by the resistor (25). Furthermore, a discharging resistor (R10, R20) is also provided on a secondary side of a driver power source circuit (27), which is a power source of a driver circuit (21) for driving a power semiconductor element (T2) configuring an inverter (12) to increase the consumption power in a driver circuit substrate (17) and promote the discharging of the smoothing capacitor (500) (Japanese Patent Application Publication No. 2011-234507: paragraphs 29 to 41; FIGS. 2 and 3, etc.).

In the configuration of Japanese Patent Application Publication No. 2011-234507, however, a high withstanding voltage element that corresponds to a maximum voltage applied to the smoothing capacitor (500) needs to be used for the resistor (25) and the discharge switching element (26) since the discharge circuit (25, 26) is connected in parallel to the smoothing capacitor (500). Therefore, downsizing and lower cost of the discharge circuit are difficult to achieve. Furthermore, if the discharging resistor (R10, R20) is provided in the driver power source circuit (27), the power is consumed even during the normal operation in which the discharge control is not carried out. Since the power consumption during the normal operation becomes large if the resistance value is reduced, there is a limit to reducing the resistance value, and it is difficult to greatly reduce the discharge time even if the discharging resistor (R10, R20) is added to the driver power source circuit (27).

### SUMMARY

In view of the above background, it is desirable to provide a discharge control device that can reduce the power consumption at the time of the normal operation in which the discharge control is not carried out, and that can rapidly discharge electrical charges accumulated in the smoothing capacitor when carrying out the discharge control, and in which the withstanding voltage and the rated power of the circuit element related to the discharging are reduced.

In view of the above problem, a discharge control device according to an exemplary aspect of the present disclosure includes: an inverter that is interposed between a high voltage DC power source and an AC device to carry out power conversion between DC and AC; a smoothing capacitor that is interposed between the high voltage DC power source and the inverter to smooth a voltage between positive and negative electrodes on the DC side of the inverter; a low voltage DC power source that is connected in parallel to the smoothing capacitor, generates a DC power having a lower voltage than the high voltage DC power source, and supplies the DC power having the low voltage to a target device different from the inverter; a discharge circuit that is connected between the positive and negative electrodes of the low voltage DC power source, between the target device and the low voltage DC power source; and a discharge control unit that controls the discharge circuit to execute discharge control of discharging electrical charges of the smoothing capacitor; in which the discharge circuit is configured by a series circuit including a discharging resistor and a discharge control switch; and the discharge control unit controls the discharge control switch to a non-conducting state during non-discharge control in which the discharge control is not executed, and controls the discharge control switch to a conducting state during execution of the discharge control.

The discharge circuit is connected between the positive and negative electrodes of the low voltage DC power source having a low voltage compared to the voltage between the positive and negative electrodes of the high voltage DC power source to which the smoothing capacitor is connected. Therefore, the rated power and the withstanding voltage of the circuit element (discharging resistor and discharge control switch) configuring the discharge circuit can be reduced compared to when the discharge circuit is provided in parallel to the smoothing capacitor. During the non-discharge control in which the discharge control is not executed, the discharge control switch is controlled to a non-conducting state, so that the discharging resistor connected in series to the discharge control switch is also in a non-conducting state, and the power is not consumed by the discharge circuit. Therefore, the power consumption at the time of the normal operation in which the discharge control is not carried out can be reduced. According to the present configuration, there is provided a discharge control device that can reduce the power consumption at the time of the normal operation in which the discharge control is not carried out, rapidly discharge electrical charges accumulated in the smoothing capacitor when carrying out the discharge control, and in which the withstanding voltage and the rated power of the circuit element related to the discharging are reduced.

During the discharge control, a large power is consumed in the discharge circuit. When the power becomes insufficient on the output side of the low voltage DC power source and the output voltage of the low voltage DC power source lowers, the inter-terminal voltage of the discharging resistor also lowers and thus the consumption power of the discharge circuit also lowers. The power is preferably supplied to maintain the consumption power of the discharge circuit in order to reduce the discharge time of the smoothing capacitor. According to one aspect of the discharge control device of the present disclosure, the low voltage DC power source preferably increases supply power compared to the time of the non-discharge control during the execution of the discharge control. A large amount of electrical charges of the smoothing capacitor are consumed when the supply power is increased, whereby the discharge time of the smoothing capacitor can be reduced.

As described above, a large power is consumed in the discharge circuit during the discharge control. When the power becomes insufficient on the output side of the low voltage DC power source, the voltage may be lowered. In order to prevent such possibility, according to one aspect of the discharge control device of the present disclosure, the low voltage DC power source is preferably a DC-DC converter including a switching element, and the DC-DC converter is preferably driven at a high switching frequency compared to the time of the non-discharge control during the execution of the discharge control. The ratio (on duty) at which the switching element is conducted and the power is supplied to the secondary side (output side) per unit time is increased when the switching frequency is raised, whereby the supply power can be increased.

In an electric automobile, a hybrid automobile, and the like, the AC power converted through the inverter from the DC power of 200 to 400 [V], for example, is supplied to the AC rotating electrical machine serving as the driving force source of the vehicle. A control signal for driving the switching element configuring the inverter is generated by the electronic circuit which is generally operated at the power source voltage of 5V or lower. Since the switching element configuring the inverter cannot be driven as is with the control signal of low voltage described above, the driver circuit that relays the control signal is generally arranged between the electronic circuit and the inverter. The power source of such driver circuit is lower than the DC voltage serving as the driving force source of the rotating electrical machine and is higher than the power source voltage of the electronic circuit that generates the control signal of the inverter. Therefore, the low voltage DC power source is preferably applied as the power source of the driver circuit. In other words, according to one aspect of the discharge control device of the present disclosure, the AC device is preferably an AC rotating electrical machine, and the target device is preferably a driver circuit that drives the switching element configuring the inverter.

When being connected to the high voltage DC power source, the smoothing capacitor preferably carries out accumulation and discharge of electrical charges with high responsiveness in accordance with the pulsation of the voltage between the positive and negative electrodes of the high voltage DC power source. When electrical connection of the smoothing capacitor and the high voltage DC power source is cut off, there is a high possibility that the operation of the AC device is stopped. In view of the manned operation after the operation of the AC device is stopped, the remaining electrical charges of the smoothing capacitor are preferably discharged as soon as possible. Therefore, the necessity of the execution of the discharge control is preferably determined according to the state of the electrical connection of the smoothing capacitor and the high voltage DC power source. According to one aspect of the discharge control device of the present disclosure, the discharge control unit preferably starts the discharge control when the electrical connection of the high voltage DC power source and the smoothing capacitor is cut off.

### BRIEF DESCRIPTION OF THE DRAWINGS

FIG. 1 a circuit block diagram schematically showing a system configuration of a discharge control device.

FIG. 2 is a circuit block diagram schematically showing an example of a power source circuit.

FIG. 3 is a view schematically showing an example of consumption power in each functional portion during non-discharge control.

FIG. 4 is a view schematically showing an example of consumption power in each functional portion during discharge control.

FIG. 5 is a circuit block diagram schematically showing a system configuration of a comparative example of the discharge control device.

FIG. 6 is a graph showing an example of a discharging characteristic of a smoothing capacitor.

FIG. 7 is a circuit block diagram schematically showing another example of a power source circuit.

### DETAILED DESCRIPTION OF EMBODIMENTS

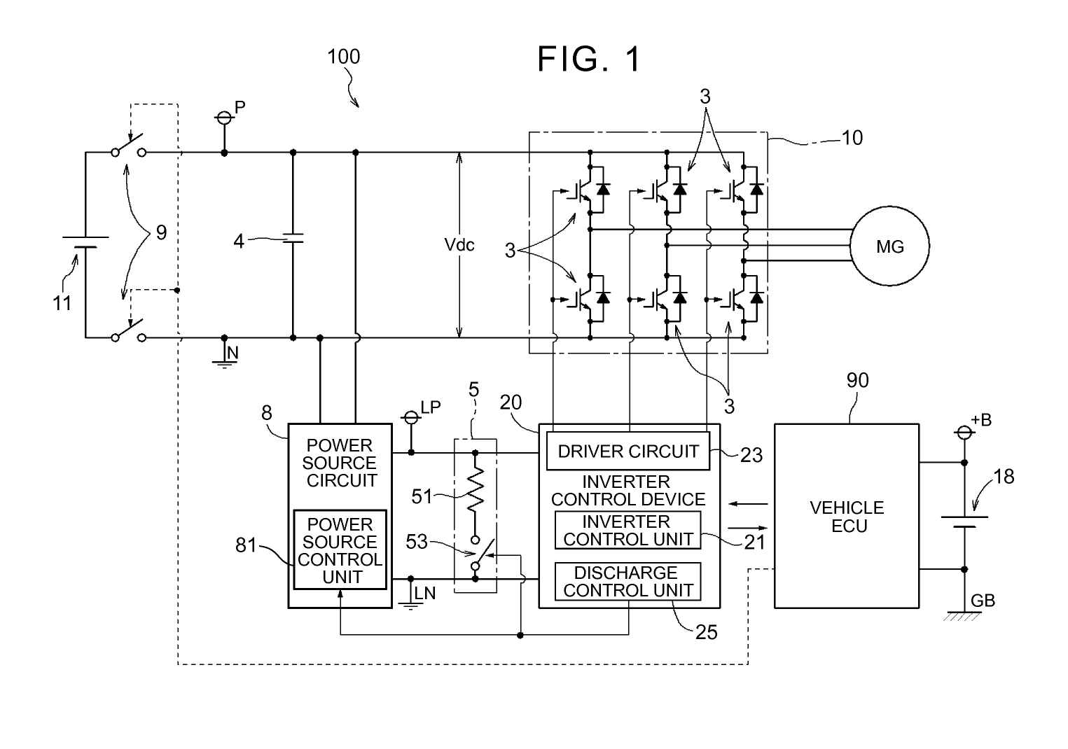

An embodiment of the present disclosure will be described using an example in which a discharge control device of the present disclosure is applied to a rotating electrical machine driving device that controls a rotating electrical machine MG serving as a driving force source of a vehicle such as a hybrid automobile, an electrical automobile, and the like. A block diagram of FIG. 1 schematically shows a configuration of a rotating electrical machine driving device 100 (discharge control device). The rotating electrical machine MG (AC device) serving as the driving force source of a vehicle is a rotating electrical machine that is operated by a multi-phase AC (three-phase AC herein), and can function as an electric motor as well as a power generator.

In vehicles such as automobiles that cannot receive power from wiring such as a railroad, a secondary battery (battery) such as a nickel hydride battery and a lithium ion battery, or a DC power source such as an electrical double-layer capacitor is mounted as a power source for driving the rotating electrical machine MG. In the present embodiment, a high voltage battery 11 (high voltage DC power source) having a power source voltage of 200 to 400 [V], for example, is provided as a large voltage large capacity DC power source that supplies power to the rotating electrical machine MG. Since the rotating electrical machine MG is an AC rotating electrical machine, an inverter 10 that carries out power conversion between the DC and the AC is provided between the high voltage battery 11 and the rotating electrical machine MG. The DC voltage between a positive electrode power source line P and a negative electrode power source line N on the DC side of the inverter 10 is hereinafter referred to as a “system voltage Vdc”. The high voltage battery 11 can supply power to the rotating electrical machine MG via the inverter 10, and can also accumulate the power generated and obtained by the rotating electrical machine MG.

A smoothing capacitor 4 for smoothing the voltage between the positive and negative electrodes (system voltage Vdc) on the DC side of the inverter 10 is provided between the inverter 10 and the high voltage battery 11. The smoothing capacitor 4 stabilizes the DC voltage (system voltage Vdc) that fluctuates according to the fluctuation of the consumption power of the rotating electrical machine MG. A contactor 9 is provided between the smoothing capacitor 4 and the high voltage battery 11 so as to be able to cut off the electrical connection of a circuit from the smoothing capacitor 4 to the rotating electrical machine MG, and the high voltage battery 11. In the present embodiment, the contactor 9 is a mechanical relay that opens and closes on the basis of a command from a vehicle ECU (electronic control unit) 90, which is one of the highest order of control devices of the vehicle, and is referred to as, for example, a SMR (system main relay).

The inverter 10 converts the DC power having the system voltage Vdc to the AC power having plural phases (n phases, n being a natural number, three phases herein) and supplies the AC power to the rotating electrical machine MG. The inverter 10 also converts the AC power generated by the rotating electrical machine MG to the DC power and supplies the DC power to the DC power source. The inverter 10 is configured to include a plurality of switching elements. A power semiconductor element such as an IGBT (insulated gate bipolar transistor) and a power MOSFET (metal oxide semiconductor field effect transistor) is preferably applied to the switching element. As shown in FIG. 1, an IGBT 3 is used as the switching element in the present embodiment.

The inverter 10 that carries out power conversion between the DC and the multi-phase AC (three-phase AC herein), for example, is configured by a bridge circuit including an arm of a number corresponding to each of the multi-phases (three phases herein) as is well known. That is, as shown in FIG. 1, two IGBTs 3 are connected in series between the DC positive electrode side (positive electrode power source line P on positive electrode side of DC power source line) and the DC negative electrode side (negative electrode power source line N on negative electrode side of DC power source) of the inverter 10 to form one arm. In the case of the three-phase AC, the series circuit (one arm) is connected in parallel for three lines (three phases). That is, the bridge circuit is configured in which a set of series circuits (arm) corresponds to each of the stator coils with a U phase, a V phase, and a W phase of the rotating electrical machine MG. An intermediate point of the pair of series circuits (arm) formed by the IGBT 3 of each phase, that is, a connecting point of the IGBT 3 on the positive electrode power source line P side and the IGBT 3 on the negative electrode power source line N side is each connected to the stator coil (not shown) of the rotating electrical machine MG.

As shown in FIG. 1, the inverter 10 is controlled by an inverter control device 20. The inverter control device 20 is configured to include an inverter control unit 21, a driver circuit 23, and a discharge control unit 25. The inverter control unit 21 is configured with a logic circuit such as a microcomputer, and the like as a core member. For example, the inverter control unit 21 carries out a current feedback control using a vector control method based on a target torque TM of the rotating electrical machine MG provided to the inverter control unit 21 as a request signal from another control device, and the like such as the vehicle ECU 90 to control the rotating electrical machine MG through the inverter 10. The inverter control unit 21 is configured to include various functional portions for the current feedback control, in which each functional portion is achieved by the cooperative operation of hardware such as the microcomputer, and software (program).

The actual current flowing through the stator coil of each phase of the rotating electrical machine MG is detected by a current sensor (not shown), and the inverter control unit 21 acquires the detection result. A magnetic pole position at each time point of the rotor of the rotating electrical machine MG is detected, for example, by a rotation sensor (not shown) such as a resolver, and the like, and the inverter control unit 21 acquires the detection result. The inverter control unit 21 performs feedback control of the rotating electrical machine MG based on the detection results of the current sensor and the rotation sensor.

In addition to the high voltage battery 11, a low voltage battery 18, which is a power source having a lower voltage than the high voltage battery 11, is mounted on the vehicle. The low voltage battery 18 and the high voltage battery 11 are insulated from each other and are in a floating relationship with each other. In other words, the ground “N” (negative electrode power source line N) of the high voltage system circuit, to which the power is supplied from the high voltage battery 11, and the ground “GB” of the low voltage system circuit, to which the power is supplied from the low voltage battery 18, are in an electrically floating relationship.

A power source voltage (+B) of the low voltage battery 18 is, for example, 12 to 24 [V]. The low voltage battery 18 supplies power to electrical components such as an audio system, a lighting device, an interior illumination, an illumination of a measuring instrument, a power window and the like, as well as a control device for controlling the same, in addition to the vehicle ECU 90. In the present embodiment, a mode has been described in which the inverter control unit 21 is operated by a power source by further lowering the low voltage DC power source generated by the power source circuit 8, to be described later, through a voltage regulator (not shown), and the like. However, the inverter control unit 21 may be operated with the power supplied from the low voltage battery 18. The power source voltage of the vehicle ECU 90, the inverter control unit 21, and the like is, for example, 5[V] or 3.3 [V].

A gate terminal, which is the control terminal of each IGBT 3 configuring the inverter 10, is connected to the inverter control unit 21 via the driver circuit 23, and is switching controlled individually. In the high voltage system circuit for driving the rotating electrical machine MG and the low voltage system circuit such as the inverter control unit 21 having the microcomputer and the like as the core, operation voltages (power source voltage of the circuit) differ greatly. Thus, the control signal of the IGBT 3 generated by the inverter control unit 21 of the low voltage system circuit is provided to the inverter 10 as a gate drive signal of the high voltage circuit system through the driver circuit 23. The driver circuit 23 is often configured using an insulating element such as a photo-coupler and a transformer.

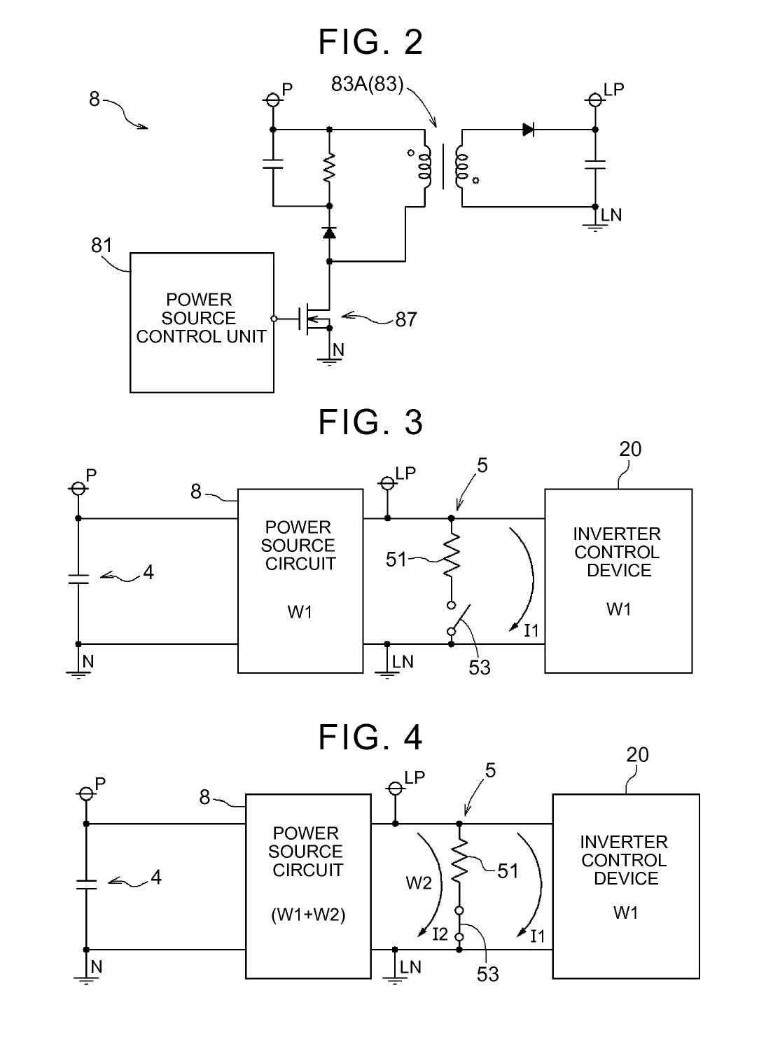

The power is supplied from the power source circuit 8 to the driver circuit 23. The power source circuit 8 is a low voltage DC power source that is connected in parallel to the smoothing capacitor 4, and that generates the DC power having a lower voltage than the high voltage battery 11 (high voltage DC power source) and that supplies the DC power having the low voltage to a target device (the driver circuit 23, etc.) different from the inverter 10. According to one mode, the power source circuit 8 is, for example, a DC-DC converter 83 that includes a switching element such as an FET 87 as shown in FIG. 2. In FIG. 2, an example in which the DC-DC converter 83 is configured by a transformer 83A is shown. The positive electrode of the low voltage DC power source is “LP” and the negative electrode is “LN”.

If the DC-DC converter 83 is configured by the transformer 83A, as shown in FIG. 2, the positive electrode (positive electrode power source line P) and the negative electrode (negative electrode power source line N) of the high voltage battery 11 are insulated from the positive electrode (LP) and the negative electrode (LN) of the low voltage DC power source so that the low voltage DC power source can be set as a floating power source. The power source circuit 8 is configured to include a power source control unit 81 that controls the switching element such as the FET 87. Although a feedback loop is not shown in FIG. 2, the power source control unit 81 monitors the output voltage of the power source circuit 8, changes the switching frequency of the FET 87, and executes the feedback control so as to output a constant output voltage (LP-LN).

Here, a case is considered in which the contactor 9 switches from the closed state to the open state. As described above, the contactor 9 is configured by a mechanical relay. Therefore, the supply of power from the high voltage battery 11 toward the inverter 10 is immediately cut off. However, the smoothing capacitor 4 is connected between the contactor 9 and the inverter 10, and such smoothing capacitor 4 is charged until its potential is the same as the high voltage battery 11 (charged until the system voltage Vdc is reached). The power source voltage of the high voltage battery 11 is, as described above, 200 to 400 [V]. Therefore, even after the contactor 9 switches to the open state, the inter-terminal voltage of the smoothing capacitor 4 does not immediately lower to the sufficiently low voltage (generally lower than or equal to 40V) at which the influence on a human body barely becomes a problem. For example, when carrying out maintenance and the like on the rotating electrical machine MG and the inverter 10, the standby time is required for the maintenance until the potential of the smoothing capacitor 4 is sufficiently lowered. The standby time is preferably as short as possible.

The contactor 9 for cutting off the electrical connection of the high voltage battery 11 and the smoothing capacitor 4 is controlled by the high order control device such as the vehicle ECU 90. For example, the information indicating that the contactor 9 has been controlled to the open state is transmitted from the vehicle ECU 90 to the inverter control device 20, and the inverter control unit 21 performs a control so as to stop the drive of the rotating electrical machine MG based on such information. The discharge control unit 25 controls the discharge circuit 5 and performs the discharge control so that the remaining electrical charges of the smoothing capacitor 4 are discharged in a shorter time. The discharge control unit 25 starts the discharge control when the electrical connection between the high voltage battery 11 and the smoothing capacitor 4 is cut off.

The discharge circuit 5 is configured by a series circuit of a discharging resistor 51 and a discharge control switch 53. The discharge circuit 5 is connected between the positive and negative electrodes (between LP-LN) of the low voltage DC power source, between the driver circuit 23 serving as the target device and the power source circuit 8 serving as the low voltage DC power source. The discharge control unit 25 controls the discharge control switch 53 to the non-conducting state during the non-discharge control in which the discharge control is not executed, and controls the discharge control switch 53 to the conducting state during the execution of the discharge control.

FIG. 3 schematically shows an example of the consumption power in each functional portion at the time of non-discharge control, and FIG. 4 schematically shows an example of the consumption power in each functional portion at the time of discharge control. A description will be made assuming the output voltage (LP-LN voltage) of the power source circuit 8 is 15 [V] and the resistance value of the discharging resistor 51 is 25 [Q] to facilitate the understanding. Furthermore, it is assumed that a constant consumption current “I1” flows to the inverter control device 20, and the consumption power “W1” is constant at 1.5 [W]. At the time of the non-discharge control, the power source circuit 8 merely needs to supply the power only to the inverter control device 20, and thus the consumption power (supply power) of the power source circuit 8 is also approximately 1.5[W] (W1).

When the discharge control is executed, on the other hand, the discharge control switch 53 is controlled to the conducting state and the discharging resistor 51 is also conducted. If the electrical resistance of the discharge control switch 53 is sufficiently small compared to the resistance value of the discharging resistor 51, the load becomes 25[Ω] with respect to the LP-LN voltage (=15[V]), and the current “I2” flowing through the load becomes 0.6[A]. Therefore, consumption power “W22” of the discharge circuit 5 becomes 9[W]. By adding the consumption power “W1” of the inverter control device 20 of 1.5[W] to “W2”, the power source circuit 8 needs to supply the power of 10.5[W] in total at the time of the discharge control.

The power source circuit 8 uses the power supplied from the positive electrode power source line P and the negative electrode power source line N to generate the low voltage power source (LP-LN). The power is not supplied from the high voltage battery 11 when the contactor 9 is in the open state, and the electrical charges accumulated in the smoothing capacitor 4 are consumed. During the execution of the discharge control, the power source circuit 8 can quickly discharge the smoothing capacitor 4 by increasing the supply power compared to the time of the non-discharge control (during normal operation).

As described above with reference to FIG. 2, the power source circuit 8 is configured as the DC-DC converter 83 that includes the FET 87. The DC-DC converter 83 can change the output power (output current if the output voltage is constant) by changing the switching frequency of the switching element such as the FET 87 (duty serving as the ratio of the ON time per unit time). As described above, the DC-DC converter 83 of the present embodiment is configured as a constant voltage source formed to include the feedback circuit (not shown). When the current consumed by the load increases, the switching frequency of the switching element such as the FET 87 is raised to increase the output current so that the output voltage does not lower.

For example, when the supply power of the power source circuit 8 is 1.5 [W], the FET 87 is assumed to be switched at 50 [kHz]. According to one mode, the switching frequency is set to 350 [kHz], which is seven times higher than the FET 87, so that the supply power of the power source circuit 8 becomes 10.5[W], which is seven times higher than 1.5[W]. In other words, during the execution of the discharge control, the supply power can be increased by driving the DC-DC converter 83 at a high switching frequency compared to the time of the non-discharge control.

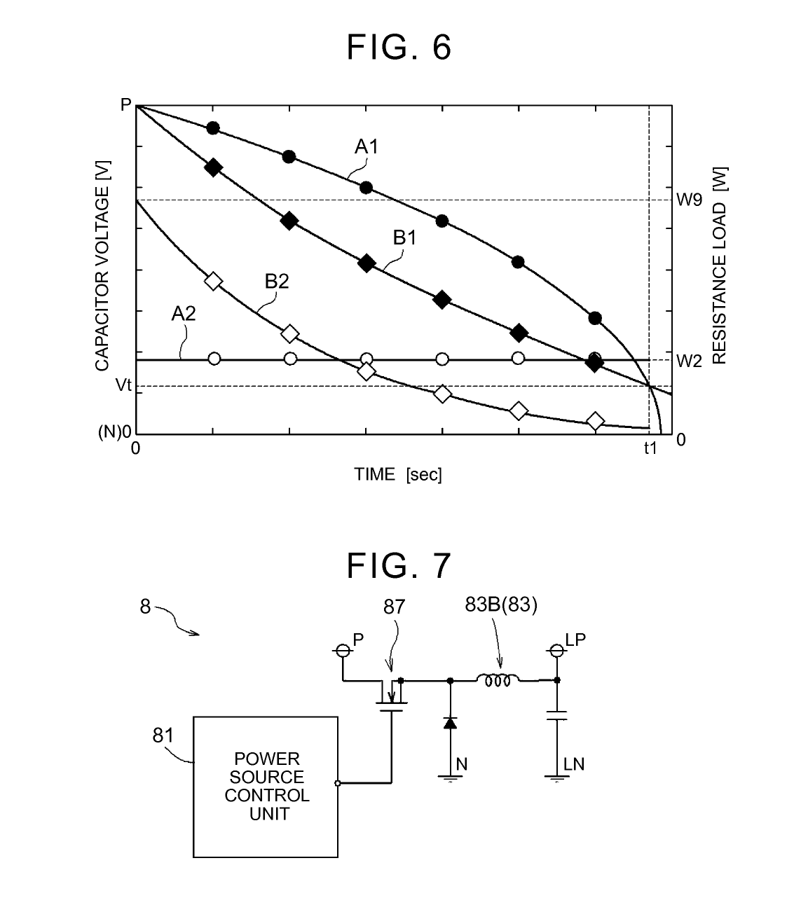

Thus, the consumption power by the discharge circuit 5 during the execution of the discharge control can be set as substantially constant by providing the discharge circuit 5 on the output side (secondary side) of the power source circuit 8 serving as the constant voltage source (see e.g., load characteristics “A2” in FIG. 6). In other words, in the present embodiment, the consumption power “W2” of the discharge circuit 5 is stabilized at approximately 9[W] during the execution of the discharge control. As a result, in the electrical specifications of the elements configuring the discharge circuit 5, the rated power of the discharging resistor 51 is 9 [W], and the withstanding voltage of the discharge control switch 53 is the output voltage of the power source circuit 8 (approximately 15[V] herein). That is, a resistor of a relatively low rated power and a switch of a relatively low withstanding voltage can be used, and the inexpensive components can be easily selected.

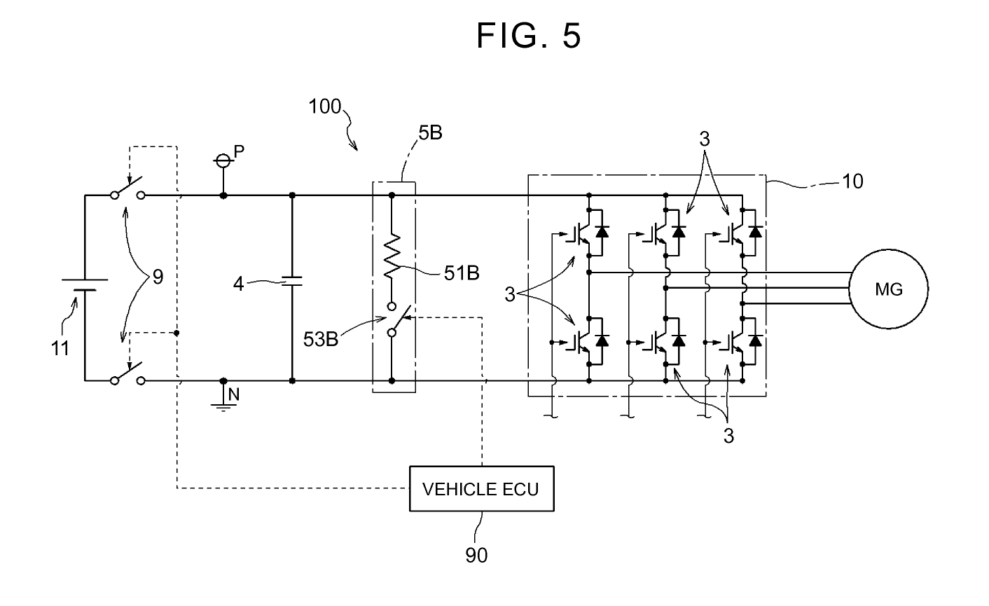

In order to gain further understanding on the superiority of the present disclosure, a case of discharging the smoothing capacitor 4 using the discharging resistor connected in parallel to the smoothing capacitor 4 and a case of discharging the smoothing capacitor 4 by applying the present disclosure will be compared. FIG. 5 schematically shows a system configuration of a comparative example of the discharge control device. In FIG. 5, only the functional portions related to a discharge circuit 5B for comparison are shown, and the other functional portions are omitted. The discharge circuit 5B is configured by a discharging resistor 51B and a discharge control switch 53B connected in series to the discharging resistor 51B. The discharge control switch 53B is controlled to be in a non-conducting state during the non-discharge control in which the discharge control is not executed and to be in a conducting state during the discharge control. When the discharge control is executed, the discharge control switch 53B is conducted, the discharging resistor 51B is also conducted, and the electrical charges accumulated in the smoothing capacitor 4 are consumed by the discharging resistor 51B.

If the resistance value of the discharging resistor 51B is 5.6 [kg)], the electrical resistance of the discharge control switch 53B is sufficiently small compared to the resistance value of the discharging resistor 51B, and thus in the discharge circuit 5B, the load is 5.6 [kΩ] with respect to the system voltage Vdc. As described above, the high voltage battery 11 is 200 to 400 [V]. Here, the system voltage Vdc at the start of the discharge control is 400 [V] and the discharging is started from a state in which the inter-terminal voltage of the smoothing capacitor 4 is 400 [V]. At the start of the discharge control, the load is 5.6 [kΩ] with respect to 400 [V], and thus the current flowing to the discharging resistor 51B is approximately 71[mA]. Therefore, the consumption power of the discharge circuit 5B is approximately 28[W].

As described above, in the discharge circuit 5 according to the preferred embodiment of the present disclosure, the rated power of the discharging resistor 51 is 9[W] and the withstanding voltage of the discharge control switch 53 is the output voltage of the power source circuit 8 (approximately 15[V] herein). On the contrary, in the discharge circuit 5B shown as a comparative example, the rated power of the discharging resistor 51B is approximately 28[W] and the withstanding voltage of the discharge control switch 53B is the maximum value of the rated voltage of the high voltage battery 11 (approximately 400[V] herein). The discharge circuit 5B of the comparative example needs to include a resistor having a large rated power and a switch having a high withstanding voltage compared to the discharge circuit 5 according to the present disclosure. Therefore, it is difficult to select an inexpensive component for the circuit element of the discharge circuit 5B. By applying the present disclosure, however, the withstanding voltage and the rated power of the circuit element related to the discharging can be reduced.

The graph of FIG. 6 shows an example of a simulation result of the discharging characteristics of the smoothing capacitor 4 when the discharge circuit 5 (FIG. 1) according to the preferred embodiment of the present disclosure is used, and when the discharge circuit 5B (FIG. 5) according to the comparative example is used. The characteristics “A1” and “A2” indicate the characteristics when the discharge circuit 5 of FIG. 1 is used, where “A1” is the terminal voltage characteristic of the smoothing capacitor 4, and “A2” is the load characteristic of the discharging resistor 51. The characteristics “B1” and “B2” indicate the characteristics when the discharge circuit 5B of FIG. 5 is used, where “B1” is the terminal voltage characteristic of the smoothing capacitor 4, and “B2” is the load characteristic of the discharging resistor 51B.

With reference to FIG. 6, at time “t1”, the terminal voltage characteristics “A1” and “B1” intersect with each other. Time “t1” is a time set within a target time of the discharge control. The terminal voltage “Vt” at the intersection is a voltage smaller than the target value (target voltage) of the terminal voltage of the smoothing capacitor 4. Therefore, satisfactory effects are obtained in both methods with respect to the discharging, and both methods are satisfactory with respect to the basic performance related to the discharge control.

The lowering speed of the terminal voltage at the beginning when the discharge control is started is faster when the discharge circuit 5B of the comparative example is used, and the rapid discharging can be achieved. However, for the discharge control, the discharging needs to be performed so that the target voltage is reached within the target time. Therefore, the discharge circuit 5 that has reached the terminal voltage “Vt”, which is smaller than the target voltage at the time “0”, can be sufficiently satisfactory for practical use.

Focusing on the load characteristics “A2” and “B2”, the load characteristic “A2” of the discharge circuit 5 according to the present disclosure is stabilized at a substantially constant value, whereas the value of the load characteristic “B2” of the discharge circuit 5B according to the comparative example is greatly changed with elapse of time. As described above, at the start of the discharge control, each of the load is 9 [W] and 28 [W], and in the discharge circuit 5B according to the comparative example, the load is about three times larger than the discharge circuit 5 according to the present disclosure. The load of the discharge circuit 5B according to the comparative example lowers with elapse of time and becomes significantly smaller than the load of the discharge circuit 5 according to the present disclosure. However, the circuit element of the discharge circuit 5B (discharging resistor 51B) needs to have a rated power corresponding to the maximum load. On the other hand, the discharging resistor 51 of the discharge circuit 5 according to the present disclosure merely needs to have a small rated power compared to the discharging resistor 51B of the discharge circuit 5B of the comparative example, thereby leading to downsizing and lower cost of the components.

According to the present disclosure, the discharge control switch 53 of the discharge circuit 5 is controlled to the conducting state only at the time of the execution of the discharge control, and hence the resistance value of the discharging resistor 51 can be set lower without taking the loss of the power at the time of the non-discharge control into consideration. That is, the discharge time of the smoothing capacitor 4 can be further reduced since the consumption power during the discharge control can be set as high as possible. Furthermore, the consumption power during the discharge control can be easily increased by raising the drive frequency of the DC-DC converter 83 (switching frequency of the FET 87). Therefore, the discharge time of the smoothing capacitor 4 can be further reduced. Meanwhile, the drive frequency is reduced in the non-discharge control. Therefore, the generation of noise can be suppressed by the relatively low drive frequency during the non-discharge control (normal operation). For example, the RFI noise that causes the in-vehicle audio device such as a radio to generate an audible noise can be suppressed.

As described above, the discharge control device to which the discharge circuit 5 is applied according to the present disclosure can reduce the power consumption at the time of the normal operation in which the discharge control is not carried out, rapidly discharge the electrical charges accumulated in the smoothing capacitor 4 when carrying out the discharge control, and can reduce the withstanding voltage and the rated power of the circuit element related to the discharging.

### OTHER EMBODIMENTS

Other embodiments of the present disclosure will now be described. The configuration of each embodiment described below is not limited to being applied in an individual manner, and may be applied in combination with the configuration of other embodiments as long as contradiction does not arise.

(1) The DC-DC converter 83 is not limited to the insulating type converter configured by the transformer 83A as described above with reference to FIG. 3. For example, a choke type converter including an inductor 83B, as shown in FIG. 7, may be adopted.

(2) The description has been made using the rotating electrical machine MG (AC device) operated by the AC power converted from the DC power of 200 to 400 [V] and the driver circuit 23 (target device) that drives the switching element configuring the inverter 10 for driving the rotating electrical machine MG. However, the case of using the driver circuit 23 as described above is not limited to the AC rotating electrical machine MG serving as a driving force source of the vehicle. The driver circuit may be used even for the rotating electrical machine operated by the AC power converted from the DC power of about several dozens of [V]. The present disclosure can be also applied to such rotating electrical machine and a drive device for driving the rotating electrical machine.

(3) The description has been made in which the contactor 9 is caused to open by the control from the vehicle ECU 90, and the execution of the discharge control is instructed by the control from the vehicle ECU 90 that performed the relevant control. However, a mode is also preferable in which it is detected that the contactor 9 has been caused to open by the control from the vehicle ECU 90 and other factors (including failure, etc.), and the discharge control unit 25 voluntarily starts the discharge control based on the detection result. For example, the present disclosure can also be applied to a case in which the electrical connection of the high voltage battery 11 and the inverter 10 is cut off by terminal detachment, disconnection, and the like in the drive device having a configuration that does not include the contactor 9 as described above.

(4) The mode has been described in which the smoothing capacitor 4 is interposed between the high voltage battery 11 and the inverter 10, but a converter for converting the DC voltage may be provided between the high voltage battery 11 and the inverter 10. In this case, for example, the smoothing capacitor 4 is provided between the converter and the inverter 10, and the contactor 9 is provided between the high voltage battery 11 and the converter. When the electrical connection of the contactor 9 and the converter is cut off, the electrical charges similarly remain in the smoothing capacitor 4, and hence the present disclosure can be applied to a device including the converter.

### INDUSTRIAL APPLICABILITY

The present disclosure can be used to a discharge control device that discharges electrical charges accumulated in the smoothing capacitor.

1. A discharge control device comprising:
an inverter that is interposed between a high voltage DC power source and an AC device to carry out power conversion between DC and AC;
a smoothing capacitor that is interposed between the high voltage DC power source and the inverter to smooth a voltage between positive and negative electrodes on the DC side of the inverter;
a low voltage DC power source that is connected in parallel to the smoothing capacitor, generates a DC power having a lower voltage than the high voltage DC power source, and supplies the DC power having the low voltage to a target device different from the inverter;
a discharge circuit that is connected between the positive and negative electrodes of the low voltage DC power source, between the target device and the low voltage DC power source; and
a discharge control unit that controls the discharge circuit to execute discharge control of discharging electrical charges of the smoothing capacitor; wherein
the discharge circuit is configured by a series circuit including a discharging resistor and a discharge control switch; and
the discharge control unit controls the discharge control switch to a non-conducting state during non-discharge control in which the discharge control is not executed, and controls the discharge control switch to a conducting state during execution of the discharge control.

2. The discharge control device according to claim 1, wherein the low voltage DC power source increases supply power compared to the time of the non-discharge control during the execution of the discharge control.

3. The discharge control device according to claim 1, wherein the low voltage DC power source is a DC-DC converter that includes a switching element, and is driven at a high switching frequency compared to the time of the non-discharge control during the execution of the discharge control.

4. The discharge control device according to claim 1, wherein the AC device is an AC rotating electrical machine, and the target device is a driver circuit that drives a switching element configuring the inverter.

5. The discharge control device according to claim 1, wherein the discharge control unit starts the discharge control when electrical connection between the high voltage DC power source and the smoothing capacitor is cut off.

6. The discharge control device according to claim 2, wherein the low voltage DC power source is a DC-DC converter that includes a switching element, and is driven at a high switching frequency compared to the time of the non-discharge control during the execution of the discharge control.

7. The discharge control device according to claim 6, wherein the AC device is an AC rotating electrical machine, and the target device is a driver circuit that drives a switching element configuring the inverter.

8. The discharge control device according to claim 7, wherein the discharge control unit starts the discharge control when electrical connection between the high voltage DC power source and the smoothing capacitor is cut off.

9. The discharge control device according to claim 2, wherein the AC device is an AC rotating electrical machine, and the target device is a driver circuit that drives a switching element configuring the inverter.

10. The discharge control device according to claim 2, wherein the discharge control unit starts the discharge control when electrical connection between the high voltage DC power source and the smoothing capacitor is cut off.

11. The discharge control device according to claim 3, wherein the AC device is an AC rotating electrical machine, and the target device is a driver circuit that drives a switching element configuring the inverter.

12. The discharge control device according to claim 11, wherein the discharge control unit starts the discharge control when electrical connection between the high voltage DC power source and the smoothing capacitor is cut off.

13. The discharge control device according to claim 3, wherein the discharge control unit starts the discharge control when electrical connection between the high voltage DC power source and the smoothing capacitor is cut off.

14. The discharge control device according to claim 4, wherein the discharge control unit starts the discharge control when electrical connection between the high voltage DC power source and the smoothing capacitor is cut off.
